(19) United States
(12) Patent Application Publication
(10) Pub. No.: US 2015/0253998 A1
(43) Pub. Date: Sep. 10, 2015

(54) MEMORY SYSTEM

(71) Applicant: Kabushiki Kaisha Toshiba, Minato-ku (JP)

(72) Inventor: Yongbum PARK, Kawasaki (JP)

(73) Assignee: Kabushiki Kaisha Toshiba, Minato-ku (JP)

(21) Appl. No.: 14/482,051

(22) Filed: Sep. 10, 2014

Related U.S. Application Data
(60) Provisional application No. 61/950,526, filed on Mar. 10, 2014.

(51) Int. Cl. G06F 3/06

(52) U.S. Cl. CPC G06F 3/0608; G06F 3/0688; G06F 3/065

(57) ABSTRACT

A memory system according to the present embodiment includes a first nonvolatile memory. A second nonvolatile memory is of a type different from that of the first nonvolatile memory. A memory controller controls the first and second nonvolatile memories. The second nonvolatile memory is used as a cache memory of the memory controller, and stores therein a logical/physical conversion data showing a correspondence relationship between a physical address of the first nonvolatile memory and a logical address of data.

### CROSS REFERENCE TO RELATED APPLICATIONS

This application is based upon and claims the benefit of priority from the prior U.S. Provisional Patent Application No. 61/950,526, filed on Mar. 10, 2014, the entire contents of which are incorporated herein by reference.

### FIELD

The embodiments of the present invention relate to a memory system.

### BACKGROUND

As large-capacity memory, a NAND-type flash memory and an MRAM (Magnetoresistive Random Access Memory) has been widely known.

### BRIEF DESCRIPTION OF THE DRAWINGS

FIG. 1 is a block diagram showing a configuration example of a memory system 1 according to a first embodiment;

FIG. 2 is a block diagram showing an example of an internal configuration of the MRAM 20;

FIG. 3 is a flowchart showing a write operation of the memory system 1 according to the first embodiment; and

FIG. 4 is a flowchart showing an operation of additionally writing data in the NAND memory 10 while setting a memory area in an SLC state to an MLC state.

### DETAILED DESCRIPTION

Embodiments will now be explained with reference to the accompanying drawings. The present invention is not limited to the embodiments.

A memory system according to the present embodiment includes a first nonvolatile memory. A second nonvolatile memory is of a type different from that of the first nonvolatile memory. A memory controller controls the first and second nonvolatile memories. The second nonvolatile memory is used as a cache memory of the memory controller, and stores therein a logical/physical conversion data showing a correspondence relationship between a physical address of the first nonvolatile memory and a logical address of data.

Components with substantially the same functionalities and configurations will be referred to with the same reference number and duplicate descriptions will be made only when required. Note that figures are schematic and the relationship between the thickness and the plane dimension of a film and the ratios of the thickness of one layer to another may differ from actual values. Therefore, it should be noted that a specific thickness and dimension should be determined in accordance with the following description. Moreover, it is natural that different figures may contain a component different in dimension and/or ratio.

As used herein the term “and/or” includes any and all combinations of one or more of the associated listed items and may be abbreviated as “/”.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “having,” “includes,” “including” and/or variations thereof, when used in this specification, specify the presence of stated features, regions, steps, operations, elements, and/or components, but do not preclude the presence or addition of one or more other features, regions, steps, operations, elements, components, and/or groups thereof.

It will be understood that when an element such as a layer or region is referred to as being “on” or extending “onto” another element (and/or variations thereof), it may be directly on or extend directly onto the other element or intervening elements may also be present. In contrast, when an element is referred to as being “directly on” or extending “directly onto” another element (and/or variations thereof), there are no intervening elements present. It will also be understood that when an element is referred to as being “connected” or “coupled” to another element (and/or variations thereof), it may be directly connected or coupled to the other element or intervening elements may be present. In contrast, when an element is referred to as being “directly connected” or “directly coupled” to another element (and/or variations thereof), there are no intervening elements present.

It will be understood that, although the terms first, second, etc. may be used herein to describe various elements, components, regions, layers and/or sections, these elements, materials, regions, layers and/or sections should not be limited by these terms. These terms are only used to distinguish one element, material, region, layer or section from another element, material, region, layer or section. Thus, a first element, material, region, layer or section discussed below could be termed a second element, material, region, layer or section without departing from the teachings of the present invention.

Relative terms, such as “lower”, “back”, and “upper” may be used herein to describe one element's relationship to another element as illustrated in the Figures. It will be understood that relative terms are intended to encompass different orientations of the device in addition to the orientation depicted in the Figures. For example, if the structure in the Figure is turned over, elements described as being on the “backside” of substrate would then be oriented on “upper” surface of the substrate. The exemplary term “upper”, may therefore, encompass both an orientation of “lower” and “upper,” depending on the particular orientation of the figure. Similarly, if the structure in one of the figures is turned over, elements described as “below” or “beneath” other elements would then be oriented “above” the other elements. The exemplary terms “below” or “beneath” can, therefore, encompass both an orientation of above and below. A NAND flash memory has a writing speed (such as 50 μs) lower than that of an SRAM or a DRAM, and data is written with a page unit in the NAND flash memory. To improve writing properties of the NAND flash memory, the following methods are considered.
1. To incorporate a volatile memory (such as an SRAM), which has a relatively higher writing speed than that of a NAND flash memory, in a memory controller. This volatile memory is used as a cache or a buffer of the memory controller.
2. To divide a NAND flash memory into an area regarded as an SLC (Single Level Cell) and an area regarded as an MLC (Multi Level Cell). The SLC has a writing speed higher than that of the MLC. By using the SLC area of the NAND flash memory as a cache or a buffer, the writing speed thereof can be improved.
3. To incorporate a volatile memory (such as an SRAM), which has a relatively higher writing speed than that of a NAND flash memory, in a memory controller, and to use the NAND flash memory as the SLC area. The volatile memory of the memory controller and/or the SLC area of the NAND flash memory are used as a cache or a buffer of the memory controller.

However, in the method 1, data stored in the nonvolatile memory (a buffer or a cache) is lost when power is shut down.

In the method 2, because a part of the NAND flash memory as a nonvolatile memory is used as a buffer or a cache, even when power is shut down, data in the buffer or the cache is not lost. However, even if an SLC is used, the NAND flash memory has a lower writing speed as compared to a volatile memory (such as an SRAM). Therefore, writing properties of the memory system cannot be fully improved.

In the method 3, a part of a nonvolatile memory or of a NAND flash memory is used as a buffer or a cache, so that the problems in the methods 1 and 2 can be dealt with. However, data stored in the volatile memory is inevitably lost when power is shut down. Furthermore, when a part of the NAND flash memory is used as a buffer or a cache, writing properties of the memory system are not fully improved.

Furthermore, although a volatile memory (such as an SRAM) in the memory controller has a high writing speed, because a layout area thereof is large, the bit cost thereof is high. Meanwhile, although the NAND flash memory has an excellent characteristic in downscaling and the bit cost thereof is low, the writing speed thereof is low. Further, in the NAND flash memory, when data is additionally written while regarding a memory area being used by an SLC as an MLC, in order to suppress data destruction caused by power loss, it is necessary to additionally write new data after backing up data, which has been previously stored in the memory area. Therefore, the number of times of data writing in the NAND flash memory is increased, and thus the life of the NAND flash memory becomes short.

### First Embodiment

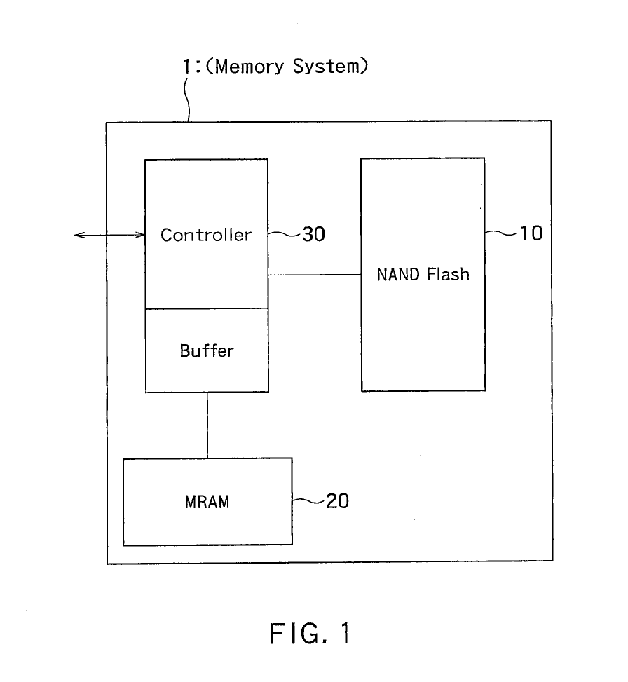

FIG. 1 is a block diagram showing a configuration example of a memory system 1 according to a first embodiment. The memory system 1 according to the first embodiment includes a NAND flash memory (hereinafter, simply “NAND memory”) 10, an MRAM 20, and a memory controller 30.

The NAND memory 10 as a first nonvolatile memory is a main memory that stores therein various pieces of information input from outside or outputs stored information to outside,

The MRAM 20 as a second nonvolatile memory is used as a cache memory of the memory controller 30, and stores therein a logical/physical conversion table (data) showing a correspondence relationship between a physical address of the NAND memory 10 and a logical address of data.

The memory controller 30 stores information from outside in the NAND memory 10 or the MRAM 20, or controls the NAND memory 10 and the MRAM 20 to output information stored in the NAND memory 10 or the MRAM 20 to outside.

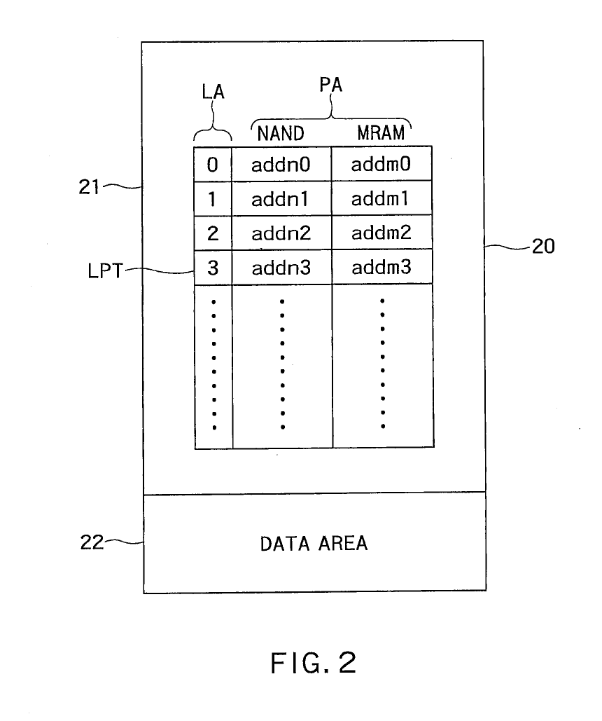

FIG. 2 is a block diagram showing an example of an internal configuration of the MRAM 20. The MRAM 20 includes a table storage area 21 and a data storage area 22. The table storage area 21 stores therein a logical/physical conversion table LPT. The logical/physical conversion table LPT includes logical addresses LA, physical addresses addn0, addn1, addn2, and onwards of the NAND memory 10, and physical addresses addm0, addm1, addm2, and onwards of the MRAM 20. The logical addresses LA respectively correspond to the physical addresses of the NAND memory 10, and also respectively correspond to the physical addresses of the MRAM 20. When the capacity of write data is less than a first capacity (for example, 64 kilobytes), the data storage area 22 temporarily stores therein the write data. In this manner, the MRAM 20 is used as a cache or a buffer.

When the capacity of write data is less than the first capacity (for example, 64 kilobytes), the memory controller 30 temporarily writes the write data in the MRAM 20 as a cache memory. In this case, when the capacity of the write data written in the MRAM 20 exceeds the first capacity, the memory controller 30 shifts the write data to the NAND memory 10. Meanwhile, when the capacity of the write data is equal to or larger than the first capacity (for example, 64 kilobytes), the memory controller 30 writes the write data in the NAND memory 10 without via the MRAM 20.

When the total capacity of the data written in the MRAM 20 becomes equal to or larger than a second capacity (for example, 128 kilobytes or 256 kilobytes), the memory controller 30 may shift the data in the MRAM chip 20 to the NAND memory 10. The second capacity can be the same as the first capacity, or can be different from the first capacity. In this manner, the memory controller 30 determines whether the data is stored in the NAND memory 10 or the MRAM 20 according to the capacity of the write data.

Although the memory controller 30 includes a buffer that temporarily stores data therein, the memory controller 30 does not take in a logical/physical conversion table from the MRAM 20. Therefore, when the memory controller 30 writes data in a cache of the NAND memory 10 or of the MRAM 20, by referring to a logical/physical conversion table stored in the MRAM 20, the memory area (a block or a page) of the storage destination is determined. In this manner, the memory controller 30 uses the MRAM 20 as a cache or a buffer.

The data storage area 22 of the MRAM 20 may temporarily store therein write data even when the capacity of the write data is equal to or larger than the first capacitor. In this case, it suffices to write the data in the NAND memory 10 after writing the data at a high speed in the data storage area 22 of the MRAM 20. In this process, although the data writing itself in the NAND memory 10 is slower than the case of writing the data in the MRAM 20, on the user side, the writing speed in the memory system 1 becomes equivalent to the writing speed in the MRAM 20.

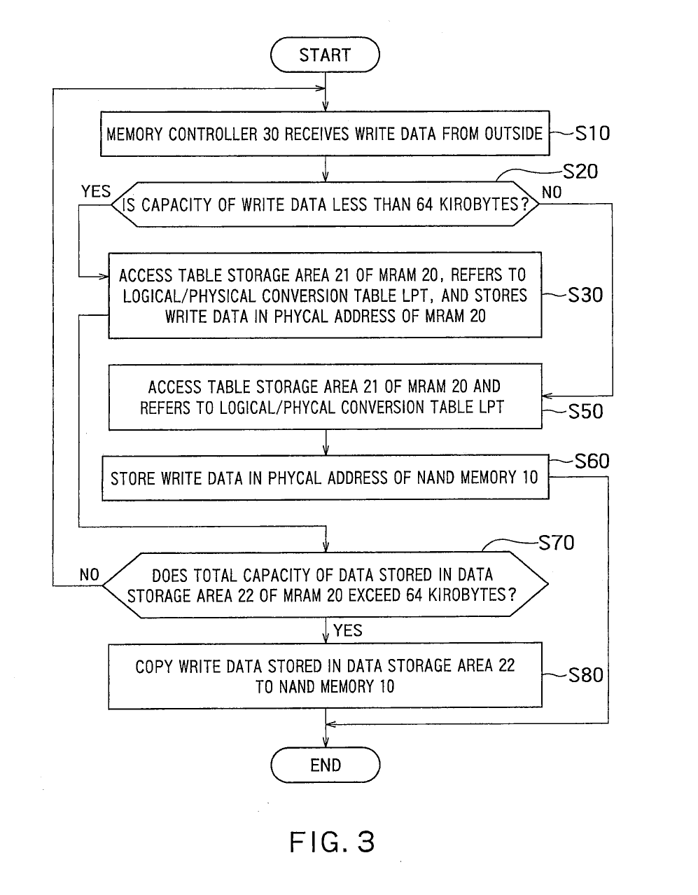

FIG. 3 is a flowchart showing a write operation of the memory system 1 according to the first embodiment. In the following explanations, the first capacity is assumed as 64 kilobytes.

First, the memory controller 30 receives write data from outside (S10). The memory controller 30 stores the write data in a buffer thereof.

The memory controller 30 determines whether the capacity of the write data is less than 64 kilobytes (S20). When the capacity of the write data is less than 64 kilobytes (YES at Step S20), the memory controller 30 accesses the table storage area 21 of the MRAM 20 and refers to the logical/physical conversion table LPT in order to specify a physical address of the MRAM 20 corresponding to a logical address of the write data. The memory controller 30 obtains information of the logical/physical conversion table LPT in the table storage area 21 of the MRAM 20 without taking in the logical/physical conversion table LPT. Thereafter, the memory controller 30 stores the write data in the physical address of the MRAM 20 (S30). At this time, the write data is stored in the data storage area 22 of the MRAM 20.

When the capacity of the write data is equal to or larger than 64 kilobytes (NO at Step S20), the memory controller 30 accesses the table storage area 21 of the MRAM 20 and refers to the logical/physical conversion table LPT (S50) in order to specify a physical address of the NAND memory 10 corresponding to the logical address of the write data. Thereafter, the memory controller 30 stores the write data in the physical address of the NAND memory 10 without via the MRAM 20 (S60). At this time, the write data is stored in the NAND memory 10.

The write operation described above is repeated, and when the total capacity of the data stored in the data storage area 22 of the MRAM 20 exceeds, for example, 64 kilobytes (YES at S70), the memory controller 30 shifts (copies) the write data stored in the data storage area 22 of the MRAM 20 to the NAND memory 10 (S80). Because the memory controller 30 is aware of the total capacity of the data stored in the data storage area 22, when the total capacity of the data exceeds 64 kilobytes, it suffices to issue a command or to raise a flag. With this process, the memory controller 30 can determine that the total capacity of the data has exceeded, for example, 64 kilobytes. At this time, the memory controller 30 accesses the table storage area 21 of the MRAM 20 and refers to the logical/physical conversion table LPT. Subsequently, it suffices that the memory controller 30 shifts the data stored in the data storage area 22 to a memory area of the NAND memory 10.

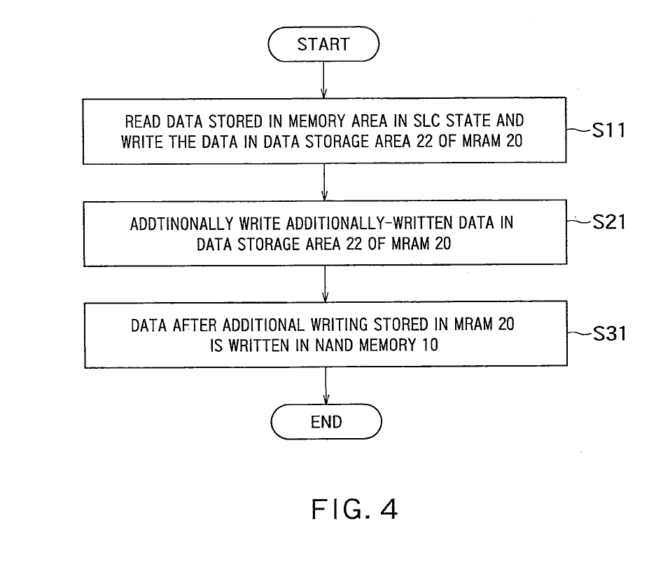

FIG. 4 is a flowchart showing an operation of additionally writing data in the NAND memory 10 while setting a memory area in an SLC state to an MLC state. In the NAND memory 10, if the MRAM 20 is not provided, it is necessary to temporarily read data stored in an SLC state and to back up the data in another memory area in order to additionally write the data in a memory area set as an SLC state. This process is needed to suppress data destruction caused by power loss. Subsequently, after adding new additionally-written data to the backed up data, the backed up data is written in a memory area same as that described above in an MLC state.

On the other hand, in the memory system 1 according to the first embodiment, when data is additionally written, the MRAM 20 is used as described below.

First, the memory controller 30 reads data stored in a first memory area in an SLC state and writes the data in the data storage area 22 of the MRAM 20 (S11).

Next, the memory controller 30 additionally writes additionally-written data input from outside in the data storage area 22 of the MRAM 20 (S21). Note that the MRAM 20 is capable of performing additional writing of data.

Subsequently, the data after additional writing, which is stored in the MRAM 20, is written in the first memory area (the same memory area) of the NAND memory 10 (S31). At this time, it suffices that the memory controller 30 writes the data as setting the memory area as an MLC state.

According to the first embodiment, the MRAM 20 functions as a cache or a buffer of the memory controller 30. The MRAM 20 is a nonvolatile memory, its access speed (writing speed) is faster than that of the NAND memory 10, and there is no limitation on the number of times of rewriting. Therefore, by including the table storage area 21 in which the MRAM 20 stores the logical/physical conversion table LPT and the data storage area 22 that temporarily stores therein small capacity data, the memory controller 30 is not required to retain a logical/physical conversion table or data in a volatile memory such as an SRAM that is provided in the memory controller 30.

Because the MRAM 20 stores therein the logical/physical conversion table LPT and small capacity data, even when power is shut down, the logical/physical conversion table LPT and the small capacity data are not lost. That is, not only the NAND memory 10 as a main memory storing data therein, but also the MRAM 20 as a cache or a buffer is a nonvolatile memory. Therefore, even when power is shut down, the stored data is maintained without being destructed.

Furthermore, it suffices that the small capacity data is stored in the MRAM 20 and copied to the NAND memory 10 when the first capacity or the second capacity is exceeded. Therefore, the memory system 1 according to the first embodiment can write the small capacity data at a high speed while storing large capacity data in the NAND memory 10, for which bit cost in inexpensive.

Further, in the first embodiment, the memory controller 30 accesses the MRAM 20 and refers to the logical/physical conversion table LPT. That is, the memory controller 30 does not need to temporarily read and retain the logical/physical conversion table LPT in an SRAM provided in the memory controller 30. This is because the memory controller 30 can access the MRAM 20 at a high speed. Therefore, when the logical/physical conversion table LPT is updated, it suffices that the memory controller 30 directly updates the logical/physical conversion table LPT stored in the MRAM 20 and there is no need to perform data backup.

Furthermore, the memory system 1 according to the first embodiment uses the NAND memory 10 as a main memory that stores therein a vast amount of information. Therefore, the bit cost can be reduced.

Further, in the NAND memory 10, when the memory area being used as an SLC is used as an MLC, in order to suppress data destruction caused by power loss, after backing up the data stored in the memory area of the SLC, it is necessary to additionally write new data. At this time, it suffices that the data being stored in the SLC and requiring backup is temporarily shifted (copied) to the MRAM 20. With this process, it becomes unnecessary to use the NAND memory 10 having a limitation of the number of times of rewriting for data back up, and thus the life of the NAND memory 10 becomes long.

As described above, the memory system 1 according to the first embodiment can solve all the problems in the methods 1 to 3 mentioned above.

In the first embodiment, a NAND memory is employed as a first nonvolatile memory and an MRAM is employed as a second nonvolatile memory. However, the first nonvolatile memory and the second nonvolatile memory, which are of a different type to each other, are not limited to a NAND memory and an MRAM, respectively. For example, a ReRAM can be employed as the second nonvolatile memory.

A memory cell array formation may be disclosed in U.S. patent application Ser. No. 12/407,403 filed on Mar. 19, 2009. U.S. patent application Ser. No. 12/407,403, the entire contents of which are incorporated by reference herein.

Furthermore, a memory cell array formation may be disclosed in U.S. patent application Ser. No. 12/406,524 filed on Mar. 18, 2009. U.S. patent application Ser. No. 12/406,524, the entire contents of which are incorporated by reference herein.

Furthermore, a memory cell array formation may be disclosed in U.S. patent application Ser. No. 12/679,991 filed on Mar. 25, 2010. U.S. patent application Ser. No. 12/679,991, the entire contents of which are incorporated by reference herein.

Furthermore, a memory cell array formation may be disclosed in U.S. patent application Ser. No. 12/532,030 filed on Mar. 23, 2009. U.S. patent application Ser. No. 12/532,030, the entire contents of which are incorporated by reference herein.

As the characteristics of a NAND memory, the following points are mentioned.

(1) In a read operation:

a voltage applied to a word line selected for an A-level read operation is within 0 V to 0.55 V, for example. However, the voltage range is not limited thereto, and it can be within any of 0.1 V to 0.24 V, 0.21 V to 0.31 V, 0.31 V to 0.4 V, 0.4 V to 0.5 V, or 0.5 V to 0.55 V;

a voltage applied to a word line selected for a B-level read operation is within 1.5 V to 2.3 V, for example. However, the voltage range is limited thereto, and it can be within any of 1.65 V to 1.8 V, 1.8 V to 1.95 V, 1.95 V to 2.1 V, or 2.1 V to 2.3 V; and

a voltage applied to a word line selected for a C-level read operation is within 3.0 V to 4.0 V, for example. However, the voltage range is limited thereto, and it can be within any of 3.0 V to 3.2 V, 3.2 V to 3.4 V, 3.4 V to 3.5 V, 3.5 V to 3.6V, or 3.6 V to 4.0 V.

As a read operation time (tR), for example, 25 μs to 38 μs, 38 μs to 70 μs, or 70 μs to 80 μs can be mentioned.

(2) A write operation includes a program operation and a verify operation. In the write operation:

a voltage applied first on a word line selected at the time of the program operation is within 13.7 V to 14.3 V, for example. However, the voltage range is limited thereto, and it can be within any one of 13.7 V to 14.0 V and 14.0 V to 14.6 V; and

A voltage applied first on a selected word line at the time of writing data using an odd-numbered word line and a voltage applied first on a selected word line at the time of writing data using an even-numbered word line can be changed.

When the program operation is assumed to employ an ISPP (Incremental Step Pulse Program) system, as a step-up voltage therefor, 0.5 V is mentioned as an example.

A voltage applied on a non-selective word line may be within 6.0 V to 7.3 V, for example. However, the voltage range is not limited thereto, and it can be within 7.3 V to 8.4 V or equal to or lower than 6.0 V.

A pass voltage to be applied can be changed depending on whether the non-selective word line is an odd-numbered word line or an even-numbered word line.

As a write operation time (tProg), for example, 1700 μs to 1800 μs, 1800 μs to 1900 μs, or 1900 μs to 2000 μs can be mentioned.

(3) In an erasure operation, a voltage applied first on a well that is formed on an upper part of a semiconductor substrate and memory cells are arranged on an upper part thereof is within 12 V to 13.6 V, for example. However, the voltage range is not limited thereto, and it can be within any of 13.6 V to 14.8 V, 14.8 V to 19.0 V, 19.0 V to 19.8 V, and 19.8 V to 21 V.

As an erasure operation time (tErase), for example, 3000 μs to 4000 μs, 4000 μs to 5000 μs, or 4000 μs to 9000 μs can be mentioned.

(4) The configuration of the memory cells has a charge accumulation layer provided on a semiconductor substrate (a silicon substrate) via a tunnel dielectric film, which has a film thickness of 4 to 10 nm. The charge accumulation layer can have a stacked structure of an insulation film such as SiN or SiOn having a film thickness of 2 to 3 nm and polysilicon having a film thickness of 3 to 8 nm. Metal such as Ru can be added to the polysilicon. An insulation film is provided on the charge accumulation layer. The insulation film includes, for example, a silicon dioxide film having a film thickness of 4 to 10 nm and being sandwiched between a lower-layer High-k film having a film thickness of 3 to 10 nm and an upper-layer High-k film having a film thickness of 3 to 10 nm. HfO can be mentioned as the High-k films. Furthermore, the film thickness of the silicon dioxide film can be made thicker than the film thickness of the High-k films. A control electrode having a film thickness of 30 nm to 70 nm is formed on the insulation film via a material for adjusting a work function having a film thickness of 3 to 10 nm. In this example, the material for adjusting a work function is a metal oxide film such as TaO or a metal nitride film such as TaN. W (Tungsten) or the like can be used for the control electrode.

An air gap can be formed between the memory cells.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A memory system comprising:
a first nonvolatile memory;
a second nonvolatile memory of a type different from a type of the first nonvolatile memory; and
a memory controller configured to control the first and second nonvolatile memories, wherein
the second nonvolatile memory is used as a cache memory of the memory controller, and stores a logical/physical conversion data showing a correspondence relationship between a physical address of the first nonvolatile memory and a logical address of data.

2. The system of claim 1, wherein
when a capacity of write data is equal to or larger than a first capacity, the memory controller writes the write data in the first nonvolatile memory,
when the capacity of the write data is less than the first capacity, the memory controller writes the write data in the second nonvolatile memory, and
when a capacity of data written in the second nonvolatile memory becomes equal to or larger than a second capacity, the memory controller shifts data in the second nonvolatile memory to the first nonvolatile memory.

3. The system of claim 1, wherein the memory controller temporarily writes write data in the second nonvolatile memory, and then shifts the write data from the second nonvolatile memory to the first nonvolatile memory.

4. The system of claim 1, wherein the memory controller temporarily writes first data in the second nonvolatile memory, the first data being stored in a first memory area of the first nonvolatile memory, the memory controller generates, in the second nonvolatile memory, second data in which additionally-written data is added to the first data, and writes the second data from the second nonvolatile memory in the first memory area of the first nonvolatile memory.

5. The system of claim 4, wherein
when the first data is stored, the first memory area stores the first data in an SLC (Single Level Cell) state, and
when the second data is written, the second data is written in the first memory area in an MLC (Multi Level Cell) state.

6. The system of claim 1, wherein
the second nonvolatile memory is accessed for referring the logical/physical conversion data, when writing the write data in the first nonvolatile memory, and
the second nonvolatile memory is accessed for referring the logical/physical conversion data, when writing the write data in the second nonvolatile memory.

7. The system of claim 2, wherein
the second nonvolatile memory is accessed for referring the logical/physical conversion data, when writing the write data in the first nonvolatile memory, and
the second nonvolatile memory is accessed for referring the logical/physical conversion data, when writing the write data in the second nonvolatile memory.

8. The system of claim 3, wherein
the second nonvolatile memory is accessed for referring the logical/physical conversion data, when writing the write data in the first nonvolatile memory, and
the second nonvolatile memory is accessed for referring the logical/physical conversion data, when writing the write data in the second nonvolatile memory.

9. The system of claim 4, wherein
the second nonvolatile memory is accessed for referring the logical/physical conversion data, when writing the write data in the first nonvolatile memory, and
the second nonvolatile memory is accessed for referring the logical/physical conversion data, when writing the write data in the second nonvolatile memory.

10. The system of claim 5, wherein
the second nonvolatile memory is accessed for referring the logical/physical conversion data, when writing the write data in the first nonvolatile memory, and
the second nonvolatile memory is accessed for referring the logical/physical conversion data, when writing the write data in the second nonvolatile memory.

11. The system of claim 4, wherein the memory controller does not take in the logical/physical conversion data from the second nonvolatile memory.

12. A driving method of a memory system, the memory system comprising a first nonvolatile memory, and a second nonvolatile memory of a type different from a type of the first nonvolatile memory, the method comprising:
writing the write data in the first nonvolatile memory when a capacity of write data is equal to or larger than a first capacity, or writing the write data in the second nonvolatile memory when the capacity of the write data is less than the first capacity, and
shifting data in the second nonvolatile memory to the first nonvolatile memory when a capacity of data written in the second nonvolatile memory becomes equal to or larger than a second capacity.

13. The method of claim 12, wherein
the second nonvolatile memory is used as a cache memory of the memory controller, and stores a logical/physical conversion data showing a correspondence relationship between a physical address of the first nonvolatile memory, a physical address of the second nonvolatile memory and a logical address of data,
the second nonvolatile memory is accessed for referring the logical/physical conversion data, when writing the write data in the first nonvolatile memory, and
the second nonvolatile memory is accessed for referring the logical/physical conversion data, when writing the write data in the second nonvolatile memory.
